(19) United States
(12) Patent Application Publication
(10) Pub. No.: US 2025/0013958 A1
(43) Pub. Date: Jan. 9, 2025

(54) DELIVERY VEHICLE MANAGEMENT SYSTEM

(71) Applicant: TOYOTA JIDOSHA KABUSHIKI KAISHA, Aichi-ken (JP)

(72) Inventors: Yohei NAKANISHI, Nagoya-shi (JP); Toshiharu FUKUMURA, Nagakute-shi (JP); Adrian NICOL, Nagoya-shi (JP); Ryuichi DANNO, Kasugai-shi (JP); Toshinori KIMURA, Ichinomiya-shi (JP); Yoshiaki ABE, Kofu-shi (JP)

(21) Appl. No.: 18/757,496

(22) Filed: Jun. 28, 2024

(30) Foreign Application Priority Data
Jul. 4, 2023 (JP) 2023-110010

(51) Int. Cl. G06Q 10/0631; G06Q 10/02; G06Q 50/47

(52) U.S. Cl. CPC G06Q 10/06316; G06Q 10/02; G06Q 50/47

(57) ABSTRACT

A delivery vehicle management system includes a database configured to manage delivery point information including information about a position of a delivery point of a package for each delivery vehicle and a controller. The controller executes acquiring a boarding position where a ride seeker desires to ride and a destination, calculating an estimated transport time for each delivery vehicle that is an estimated value of a time the delivery vehicle takes to travel from the boarding position to the destination, and assigning the ride seeker one of the delivery vehicles that differs from the delivery vehicle having the longest estimated transport time.

### CROSS-REFERENCE TO RELATED APPLICATIONS

This application is based upon and claims the benefit of priority from prior Japanese Patent Application No. 2023-110010, filed on Jul. 4, 2023, the entire contents of which are incorporated herein by reference.

### BACKGROUND

### 1. Field

The present disclosure relates to a delivery vehicle management system that manages a delivery vehicle that delivers a package to a delivery point.

### 2. Description of Related Art

Japanese Laid-Open Patent Publication No. 2020-149612 discloses a control device that determines a vehicle that transports a user from a boarding position desired by the user to a deboarding position desired by the user. The control device acquires information about the boarding position and the deboarding position from an information terminal carried by the user. The control device allows the user to use a vehicle when at least one of the boarding position and the deboarding position is located in the business district of a transportation company.

A service using a vehicle for transporting a user from a boarding position to a deboarding position may be realized using a delivery vehicle used for package delivery. In this case, the delivery vehicle performs all of delivering a package to the delivery point, going to the boarding position to pick up the user, and transporting the user from the boarding position to the deboarding position. Therefore, after the user gets on the delivery vehicle at the boarding position, the delivery vehicle travels toward the deboarding position while stopping at the delivery point of the package. In this case, while the delivery vehicle is traveling from the boarding position toward the deboarding position, as the number of delivery points to which the delivery vehicle delivers packages is increased, it takes the delivery vehicle a longer time to travel from the boarding position to the deboarding position. As a result, the user may feel inconvenience.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a system configured to manage delivery vehicles that deliver packages to delivery points and to select, from the delivery vehicles, a delivery vehicle that transports a ride seeker to a destination of the ride seeker. A delivery vehicle management system includes a database configured to manage, for each delivery vehicle, delivery point information including information about positions of delivery points of packages delivered by the delivery vehicles and a controller including processing circuitry. The processing circuitry is configured to execute acquiring the destination and a boarding position at which the ride seeker desires to ride, calculating an estimated transport time for each delivery vehicle that is an estimated value of a time the delivery vehicle takes to travel from the boarding position to the destination based on the delivery point information, and assigning the ride seeker one of the delivery vehicles that differs from a delivery vehicle having a longest estimated transport time.

Other features and aspects will be apparent from the following detailed description, the drawings, and the claims.

### BRIEF DESCRIPTION OF THE DRAWINGS

FIG. 1 is a configuration diagram illustrating a delivery vehicle management system according to a first embodiment, an information terminal owned by a user, and a plurality of delivery vehicles managed by the system.

FIG. 2 is a diagram showing information registered in a database included in the delivery vehicle management system of the first embodiment.

FIG. 3 is a sequence diagram showing a flow of processing when a service is provided to a user in the delivery vehicle management system of the first embodiment.

FIG. 4 is a schematic diagram showing an example of a delivery schedule of a target delivery vehicle.

FIG. 5 is a sequence diagram showing a flow of processing when a service is provided to a user in the delivery vehicle management system of the second embodiment.

FIG. 6 is a schematic view showing a separation distance of a position of a delivery point from a reference route in the delivery vehicle management system of the second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

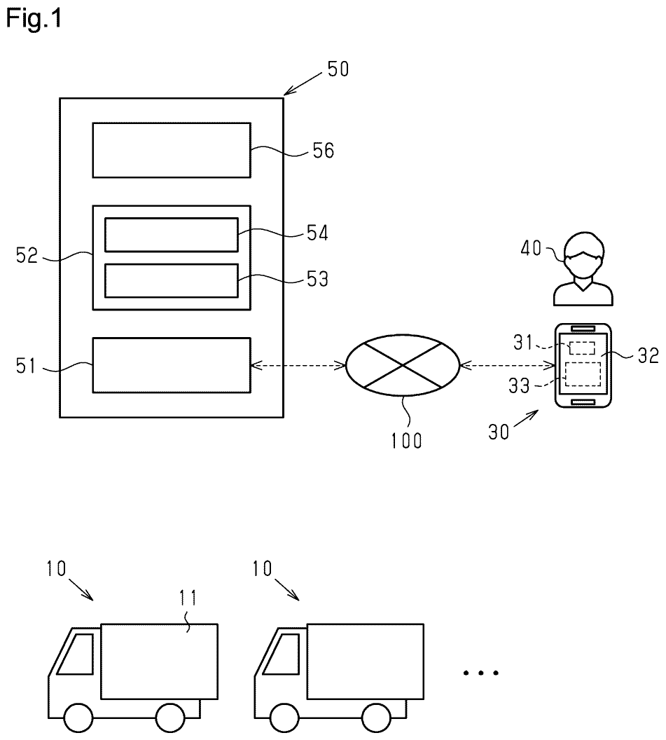

Hereinafter, a first embodiment of a delivery vehicle management system will be described with reference to FIGS. 1 to 4.

FIG. 1 illustrates a delivery vehicle management system 50, a plurality of delivery vehicles 10, and an information terminal 30. The delivery vehicle management system 50 manages a plurality of delivery vehicles 10 that deliver packages to delivery points. In addition, the delivery vehicle management system 50 has a function of determining the delivery vehicle 10 to be assigned to the user 40 of the following service from among the plurality of delivery vehicles 10. The above-described service is a service in which the user 40 is delivered by the delivery vehicle 10 from a boarding position desired by the user 40 to a destination while the delivery vehicle 10 is delivering a package to a delivery point.

### Delivery Vehicle

For example, each of the plurality of delivery vehicles 10 has a loading platform 11 on which a package can be loaded. The delivery vehicle 10 delivers the package to the delivery point in accordance with the delivery schedule set by the delivery vehicle management system 50.

### Information Terminal

The information terminal 30 is a communication terminal owned by the user 40. Examples of the information terminal 30 include a smartphone, a tablet terminal, and a personal computer.

The information terminal 30 includes a communication device 31, a user interface 32, and processing circuitry 33. The communication device 31 outputs information received from the delivery vehicle management system 50 via the communication network 100 to the processing circuitry 33. The communication device 31 transmits information output from the processing circuitry 33 to the delivery vehicle management system 50 via the communication network 100.

The user interface 32 includes a display screen and an operation unit. An example of the processing circuitry 33 is an electronic control device. When the operation unit is operated by the user 40, the processing circuitry 33 executes processing corresponding to the operation. When the communication device 31 receives information from the delivery vehicle management system 50 via the communication network 100, the processing circuitry 33 causes the information received by the communication device 31 to be displayed on the display screen of the user interface 32.

For example, when using the above-described service, the user 40 operates the operation unit of the user interface 32 to input the date and time of use, the boarding position, and the destination desired by the user. Then, various kinds of information input by the user are transmitted from the communication device 31 to the delivery vehicle management system 50. In this case, the user 40 who uses the service corresponds to a “ride seeker” who desires to ride in the delivery vehicle 10.

### Delivery Vehicle Management System

The delivery vehicle management system 50 includes a communication device 51, a controller 52, and a database 56.

The communication device 51 is an interface of the delivery vehicle management system 50 for transmitting and receiving information to and from an external communication device via the communication network 100. For example, the communication device 51 outputs information received via the communication network 100 to the controller 52. Further, for example, the communication device 51 transmits information output by the controller 52 to the information terminal 30 via the communication network 100.

An example of the controller 52 is an electronic control device. In this case, the controller 52 has a CPU53 and a memory 54. The memory 54 stores a control program executed by the CPU53. When the CPU53 executes the control program, the controller 52 executes a process of creating the delivery schedule SC of the delivery vehicle 10, a process of providing the service to the user 40, and the like. The contents of such processing will be described later.

In the database 56, information necessary for the controller 52 to create the delivery schedules SC of the plurality of delivery vehicles 10 is registered.

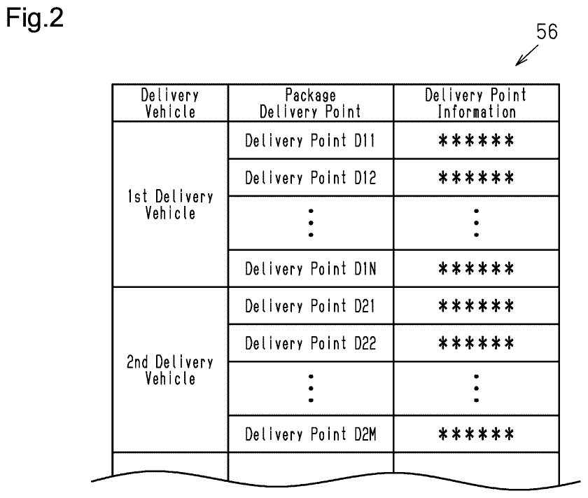

The information registered in the database 56 will be described with reference to FIG. 2. In the database 56, delivery point information about a plurality of delivery points is registered. The delivery point information includes information related to the position of the delivery point. An example of the location of the delivery point is an address of the delivery point.

For example, in the database 56, the delivery point information about N delivery points D11, D12, . . . , DIN is registered as the delivery point of the package delivered by the first delivery vehicle among the plurality of delivery vehicles 10. In the database 56, delivery point information about M delivery points D21, D22, . . . , DIM is registered as delivery points of packages to be delivered by the second delivery vehicle among the plurality of delivery vehicles 10. Here, “N” and “M” are integers equal to or greater than 2.

Flow of Processing when Providing Service to User

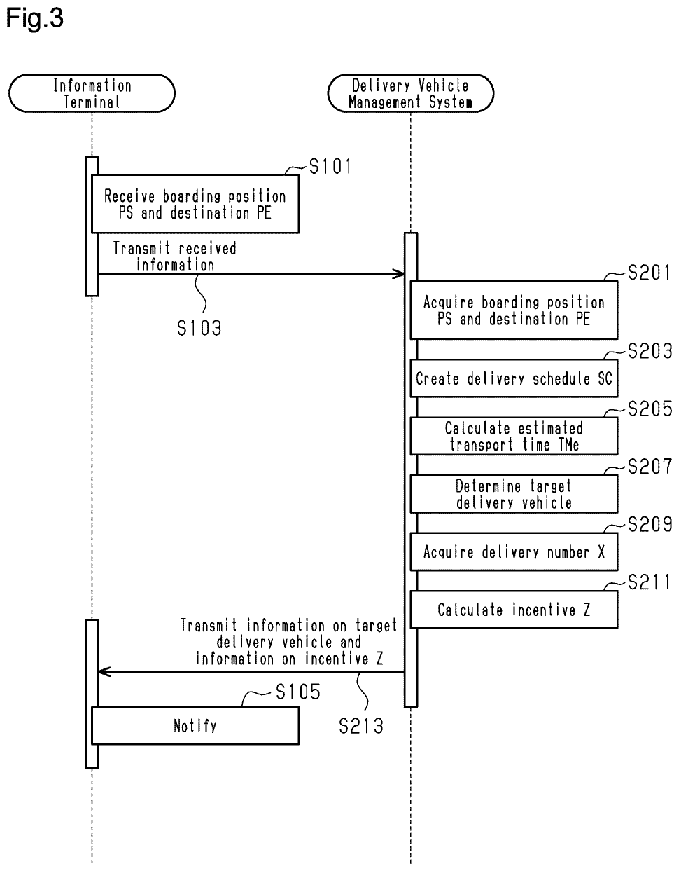

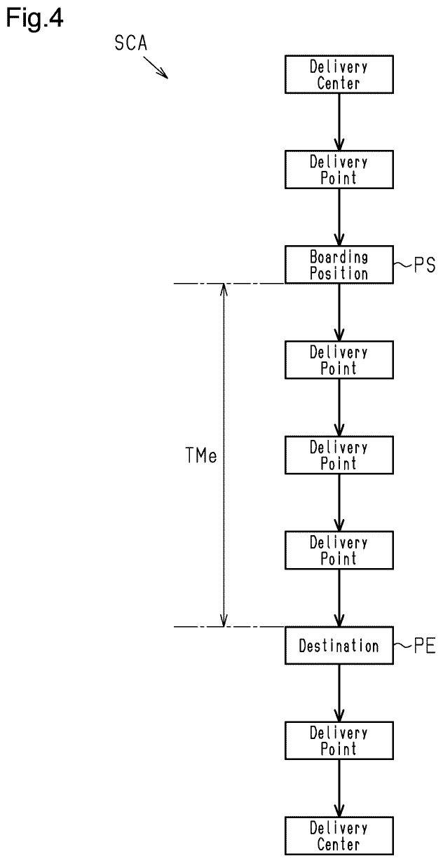

With reference to FIG. 3 and FIG. 4, a flow of processing when the service is provided to the user 40 will be described.

When using the service, the user 40 operates the operation unit of the user interface 32 of the information terminal 30 of the user 40. Thus, as shown in FIG. 3, in step S101, the processing circuitry 33 of the information terminal 30 receives a boarding position PS and a destination PE desired by the user 40. In subsequent step S103, the communication device 31 of the information terminal 30 transmits the information received by the processing circuitry 33 in step S101 to the delivery vehicle management system 50 via the communication network 100.

When the communication device 51 of the delivery vehicle management system 50 receives the information transmitted from the information terminals 30, the controller 52 of the delivery vehicle management system 50 executes the process of step S201.

In step S201, the controller 52 acquires the boarding position PS and the destination PE desired by the user. In the subsequent step S203, the controller 52 creates the delivery schedule SC of the plurality of delivery vehicles 10 based on the registration information about the database 56. In a case where the delivery schedule SC of the first delivery vehicle is created, for example, the controller 52 creates the delivery schedule SC of the first delivery vehicle such that the time to complete the delivery of the packages to all of the delivery points is the shortest.

In the next step S205, the controller 52 calculates an estimated transport time TMe for each delivery vehicle 10 based on the delivery point information registered in the database 56. The estimated transport time TMe is an estimated value of the time the delivery vehicle 10 takes to travel from the boarding position PS to the destination PE.

An example of calculating the estimated transport time TMe of the first delivery vehicle will be described with reference to FIG. 4. First, the controller 52 corrects the delivery schedule SC of the first delivery vehicle created in step S203 on the basis of the boarding position PS and the destination PE. That is, the controller 52 corrects the delivery schedule SC of the first delivery vehicle such that the first delivery vehicle travels to the boarding position PS and the destination PE in the middle of delivery. For example, the controller 52 corrects the delivery schedule SC so that the first delivery vehicle can deliver the package to another delivery point while heading for the destination PE after delivering the package to the delivery point near the boarding position PS. FIG. 4 illustrates an example of the delivery schedule SC corrected by the controller 52 as described above. The corrected delivery schedule SC is referred to as a “delivery schedule SCA.”

Then, the controller 52 calculates the estimated transport time TMe of the first delivery vehicle based on the corrected delivery schedule SCA. For example, the controller 52 calculates, as the estimated transport time TMe, an estimated value of the time to travel from the boarding position PS to the destination PE in a case where the first delivery vehicle delivers the package according to the delivery schedule SCA. At this time, the controller 52 may calculate the estimated transport time TMe such that the longer the travel distance of the travel route from the boarding position PS to the destination PE is, the longer the estimated transport time TMe is. The traveling route mentioned here is a traveling route in consideration of the first delivery vehicle stopping at the delivery point on the way from the boarding position PS to the destination PE.

Returning to FIG. 3, when the controller 52 calculates the estimated transport times TMe of all the delivery vehicles 10, the controller 52 shifts the processing to step S207. In step S207, the controller 52 determines a target delivery vehicle, which is a delivery vehicle to be assigned to the user 40, from among the plurality of delivery vehicles 10. That is, the controller 52 determines, as the target delivery vehicle, a delivery vehicle that differs from the delivery vehicle having the longest estimated transport time TMe among the plurality of delivery vehicles 10.

In the present embodiment, the controller 52 determines, as the target delivery vehicle, a delivery vehicle having the fewest delivery points to which the package is to be delivered on the way from the boarding position PS to the destination PE among the plurality of delivery vehicles 10 other than the reference delivery vehicle. The “reference delivery vehicle” referred to herein is the delivery vehicle 10 having the longest estimated transport time TMe among the plurality of delivery vehicles 10. The number of delivery points to which packages are to be delivered on the way from the boarding position PS to the destination PE is referred to as a “delivery number.”

In the next step S209, the controller 52 acquires the number of delivery points to which the delivery vehicle 10 determined as the target delivery vehicle delivers the package on the way from the boarding position PS to the destination PE as the delivery number X. When the delivery schedule SCA of the target delivery vehicle is the schedule shown in FIG. 4, the controller 52 acquires 3 as the delivery number X.

In subsequent step S211, the controller 52 calculates the incentive Z provided to the user 40. For example, the controller 52 calculates the incentive Z such that the value of the incentive Z increases as the delivery number X increases. Thus, the controller 52 can provide a larger incentive Z to the user 40 as the delivery number X is increased. As the incentive Z, for example, a discount ticket of a fee which can be used when the service is used next time or later, a point which can be used when a product is purchased, and the like can be exemplified.

Then, in step S213, the communication device 51 of the delivery vehicle management system 50 transmits information on the target delivery vehicle and information on the incentive Z to the information terminals 30 of the users 40 via the communication network 100.

When the information transmitted by the delivery vehicle management system 50 is received by the communication device 31 of the information terminal 30, the information terminal 30 proceeds to the process of step S105.

In step S105, the processing circuitry 33 of the information terminal 30 notifies the user 40 of the information received from the delivery vehicle management system 50. For example, the processing circuitry 33 displays the information on the target delivery vehicle and the information on the incentive Z on the display screen of the user interface 32.

### Operation and Advantages of Present Embodiment

(1-1) When acquiring a boarding position PS and a destination PE transmitted from the information terminal 30 of the user 40, the controller 52 of the delivery vehicle management system 50 calculates an estimated transport time TMe for each delivery vehicle 10. Then, the controller 52 selects, as a target delivery vehicle from the delivery vehicles 10, a delivery vehicle differing from the reference delivery vehicle.

The target delivery vehicle travels toward the boarding position PS while delivering a package to the delivery point. When the target delivery vehicle allows the user 40 to board at the boarding position PS, the target delivery vehicle travels toward the destination PE. At this time, the target delivery vehicle travels toward the destination PE while delivering the package to the delivery point. Then, when the target delivery vehicle arrives at the destination PE, the user 40 gets off the target delivery vehicle.

In the present embodiment, a delivery vehicle that differs from the reference delivery vehicle is selected as the target delivery vehicle. Thus, the time the target delivery vehicle takes to travel from the boarding position PS to the destination PE is less likely to be long. Therefore, the delivery vehicle management system 50 improves the convenience of the service for transporting the user from the boarding position PS to the destination PE by the delivery vehicle 10.

(1-2) As the delivery number X, which is the number of delivery points to which the target delivery vehicle delivers packages during a period from when the user 40 boards the target delivery vehicle until the target delivery vehicle arrives at the destination PE, is increased, the user 40 of the target delivery vehicle is more likely to feel uncomfortable. In this regard, the controller 52 of the delivery vehicle management system 50 selects the delivery vehicle 10 having the smallest delivery number X as the target delivery vehicle from the delivery vehicles 10 excluding the reference delivery vehicle. This reduces the number of delivery points to which the target delivery vehicle delivers packages while the target delivery vehicle is traveling from the boarding position PS to the destination PE. Thus, the delivery vehicle management system 50 reduces the discomfort of the user 40, riding the target delivery vehicle, caused by the target delivery vehicle stopping at the delivery points while traveling from the boarding position PS to the destination PE.

(1-3) The delivery vehicle management system 50 is configured to provide a larger incentive Z to the user 40 as the delivery number X is increased. The delivery vehicle management system 50 provides the user 40 with an incentive Z corresponding to the delivery number X. This reduces the discomfort of the user 40, riding the target delivery vehicle, caused by the target delivery vehicle stopping at the delivery points while traveling from the boarding position PS to the destination PE.

### Second Embodiment

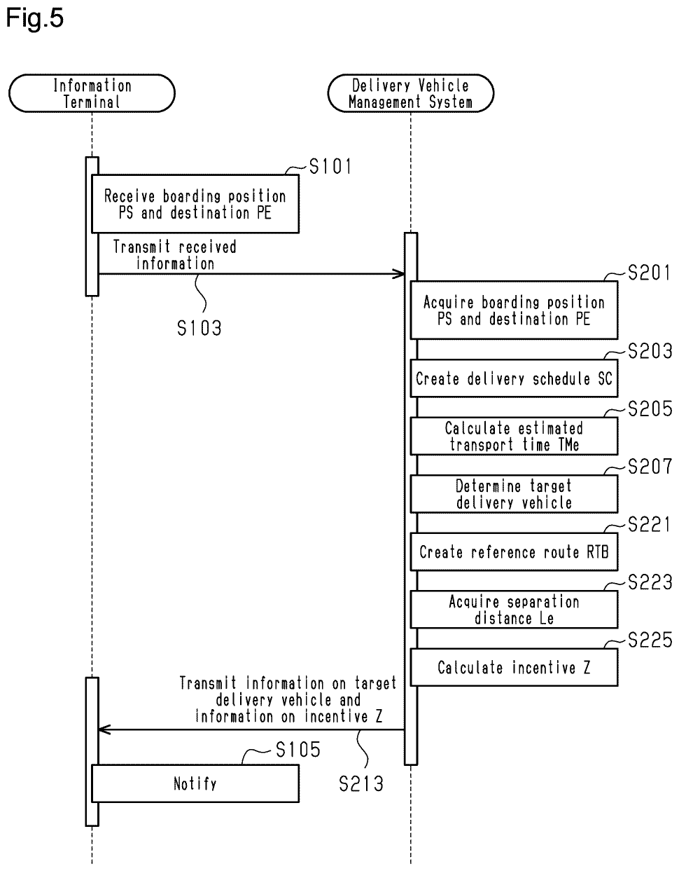

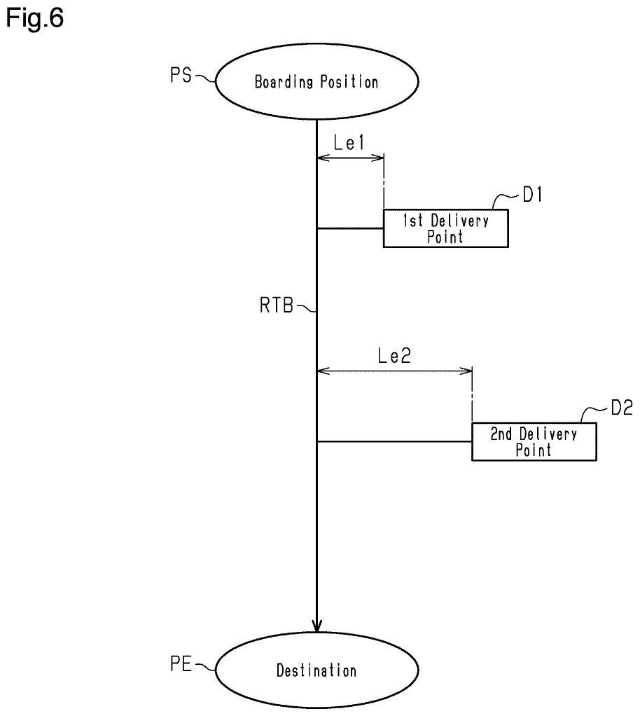

A second embodiment of the delivery vehicle management system will be described with reference to FIGS. 5 and 6. The second embodiment is different from the first embodiment in the incentive calculation method and the like. In the following description, portions different from those of the first embodiment will be mainly described, and the same members and configurations as those of the first embodiment will be denoted by the same reference numerals, and redundant description thereof will be omitted.

With reference to FIG. 5 and FIG. 6, a flow of processing when the service is provided to the user 40 will be described.

When using the service, the user 40 operates the operation unit of the user interface 32 of the information terminal 30 of the user 40. Thus, as illustrated in FIG. 5, in step S101, the processing circuitry 33 of the information terminal 30 receives the boarding position PS and the destination PE desired by the user 40. In subsequent step S103, the communication device 31 of the information terminal 30 transmits the information received by the processing circuitry 33 in step S101 to the delivery vehicle management system 50 via the communication network 100.

When the communication device 51 of the delivery vehicle management system 50 receives the information transmitted from the information terminals 30, the controller 52 of the delivery vehicle management system 50 executes the process of step S201.

The controller 52 sequentially executes each process of a plurality of steps S201 to S207. The flow of this processing is the same as in the case of the first embodiment. When the controller 52 determines the target delivery vehicle from among the plurality of delivery vehicles 10, the controller 52 executes the process of step S221.

In step S221, the controller 52 creates the reference route RTB of the target delivery vehicle based on the boarding position PS and the destination PE. The reference route RTB is a traveling route of the target delivery vehicle in a case where it is assumed that the target delivery vehicle travels from the boarding position PS to the destination PE without stopping at the delivery point on the way.

In subsequent step S223, the controller 52 acquires the separation distance Le from the reference route RTB of the position of the delivery point to which the target delivery vehicle delivers the package while the target delivery vehicle is traveling from the boarding position PS to the destination PE, based on the delivery point information about the target delivery vehicle and the reference route RTB.

FIG. 6 schematically shows an example of the reference route RTB. In the example illustrated in FIG. 6, a first delivery point D1 and a second delivery point D2 are illustrated as delivery points to which the target delivery vehicle delivers the package on the way. The controller 52 acquires the separation distance Le1 of the first delivery point D1 from the reference route RTB based on the position information about the reference route RTB and the position information about the first delivery point D1. Similarly, the controller 52 acquires the separation distance Le2 of the second delivery point D2 from the reference route RTB based on the position information about the reference route RTB and the position information about the second delivery point D2.

Returning to FIG. 5, when the controller 52 acquires the separation distance Le, the controller 52 proceeds to the process of step S225. In step S225, the controller 52 calculates the incentive Z provided to the user 40. For example, the controller 52 calculates the incentive Z such that the longer the separation distance Le acquired in step S223 is, the larger the value of the incentive Z is. Thus, the controller 52 can provide the user 40 with a larger incentive Z as the separation distance Le is longer. In the example illustrated in FIG. 6, while the target delivery vehicle is delivering the user 40 from the boarding position PS to the destination PE, the target delivery vehicle delivers the package to the first delivery point D1 and the second delivery point D2. Then, in step S223, the controller 52 acquires the separation distance Le1 from the reference route RTB to the first delivery point D1 and the separation distance Le2 from the reference route RTB to the second delivery point D2. Therefore, the controller 52 may provide the user 40 with the incentive Z corresponding to the longer separation distance Le1 among the acquired separation distances Le2 and Le2. Further, the controller 52 may give the user 40 an incentive Z corresponding to the sum of the acquired separation distances Le1 and Le2.

Then, in step S213, the communication device 51 of the delivery vehicle management system 50 transmits information on the target delivery vehicle and information on the incentive Z to the information terminals 30 of the users 40 via the communication network 100.

When the information transmitted by the delivery vehicle management system 50 is received by the communication device 31 of the information terminal 30, the information terminal 30 proceeds to the process of step S105.

In step S105, the processing circuitry 33 of the information terminal 30 notifies the user 40 of the information received from the delivery vehicle management system 50. For example, the processing circuitry 33 displays the information on the target delivery vehicle and the information on the incentive Z on the display screen of the user interface 32.

### Operation and Advantages of Present Embodiment

In the present embodiment, the following effects can be further obtained in addition to the effects equivalent to the effects (1-1) and (1-2) of the first embodiment.

(2-1) The controller 52 of the delivery vehicle management system 50 acquires the separation distance Le from the reference route RTB to the position of the delivery point to which the target delivery vehicle delivers the package while traveling from the boarding position PS to the destination PE. The controller 52 provides the user 40 with a larger incentive Z as the separation distance Le is increased. The delivery vehicle management system 50 provides the user 40 with an incentive Z corresponding to the separation distance Le. This reduces the discomfort of the user 40, riding the target delivery vehicle, caused by the target delivery vehicle stopping at the delivery points while traveling from the boarding position PS to the destination PE.

### Modified Examples

The above-described embodiments may be modified as follows. The above-described embodiments and the following modifications can be combined as long as the combined modifications remain technically consistent with each other.

In a case where the incentive Z is given to the user 40, the delivery vehicle management system 50 may calculate the incentive Z in consideration of both the delivery number X and the separation distance Le. For example, the controller 52 may calculate the incentive Z such that the value of the incentive Z increases as the delivery number X increases, and the value of the incentive Z increases as the separation distance Le increases.

The delivery vehicle management system 50 may not give the incentive Z to the user 40.

The controller 52 of the delivery vehicle management system 50 may allocate a delivery vehicle having the shortest estimated transport time TMe among the plurality of delivery vehicles 10 to the user 40.

The controller 52 is not limited to a device that includes a CPU and a ROM and executes software processing. That is, the controller 52 may have any one of the following configurations (a), (b), and (c).

(a) The controller 52 includes one or more processors that execute various processes in accordance with a computer program. Each processor includes a CPU and a memory, such as a RAM and a ROM. The memory stores program codes or instructions configured to cause the CPU to execute processes. The memory, which is a computer-readable medium, includes any type of media that are accessible by general-purpose computers and dedicated computers.

(b) The controller 52 includes one or more dedicated hardware circuits that execute various processes. The dedicated hardware circuits include, for example, an application specific integrated circuit (ASIC) and a field programmable gate array (FPGA). Note that ASIC is an abbreviation of “Application Specific Integrated Circuit,” and FPGA is an abbreviation of “Field Programmable Gate Array.”

(c) The controller 52 includes a processor that executes some of the various processes in accordance with a computer program, and a dedicated hardware circuit that executes the remaining processes of the various processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A delivery vehicle management system configured to manage delivery vehicles that deliver packages to delivery points and to select, from the delivery vehicles, a delivery vehicle that transports a ride seeker to a destination of the ride seeker, the delivery vehicle management system, comprising:
a database configured to manage, for each delivery vehicle, delivery point information including information about positions of delivery points of packages delivered by the delivery vehicles; and
a controller including processing circuitry, wherein
the processing circuitry is configured to execute
acquiring the destination and a boarding position at which the ride seeker desires to ride,
based on the delivery point information, calculating an estimated transport time for each delivery vehicle that is an estimated value of a time the delivery vehicle takes to travel from the boarding position to the destination, and
assigning the ride seeker one of the delivery vehicles that differs from a delivery vehicle having a longest estimated transport time.

2. The delivery vehicle management system according to claim 1, wherein
among the delivery vehicles, the delivery vehicle having the longest estimated transport time is referred to as a reference delivery vehicle, and
the processing circuitry is configured to, when determining a delivery vehicle that is assigned to the ride seeker, assign the ride seeker one of the delivery vehicles excluding the reference delivery vehicle that delivers packages to fewest delivery points while traveling from the boarding position to the destination.

3. The delivery vehicle management system according to claim 1, wherein
a delivery vehicle assigned to the ride seeker is referred to as a target delivery vehicle,
the processing circuitry is configured to execute
creating a delivery schedule of the target delivery vehicle based on the boarding position, the destination, and the delivery point information on the target delivery vehicle,
based on the delivery schedule of the target delivery vehicle, acquiring a delivery number that is a number of delivery points to which the target delivery vehicle delivers packages while traveling from the boarding position to the destination, and
providing the ride seeker with a larger incentive as the delivery number is increased.

4. The delivery vehicle management system according to claim 1, wherein
a delivery vehicle assigned to the ride seeker is referred to as a target delivery vehicle, and
the processing circuitry is configured to execute
creating a reference route that is a traveling route of a delivery vehicle when the delivery vehicle is assumed to travel from the boarding position to the destination without stopping at the delivery point,
based on the reference route and the delivery point information about a delivery point to which the target delivery vehicle delivers a package, acquiring a separation distance from the reference route to a position of the delivery point to which the target delivery vehicle delivers the package while the target delivery vehicle is traveling from the boarding position to the destination, and
providing the ride seeker with a larger incentive as the separation distance is increased.
